(19) United States
(12) Patent Application Publication
(10) Pub. No.: US 2010/0295856 A1
(43) Pub. Date: Nov. 25, 2010

(54) DATA ANALYSIS AND VISUALIZATION SYSTEM AND TECHNIQUES

(75) Inventors: Alexandre G. Ferreira, Sammamish, WA (US); Jose H. Baldner, Redmond, WA (US); Nelson Araujo, Redmond, WA (US); Huseyin S. Yildiz, Kenmore, WA (US); Zhaohui Zhu, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/470,314

(22) Filed: May 21, 2009

(51) Int. Cl. G06T 11/20; G06T 1/00

(52) U.S. Cl. 345/441; 345/418

(57) ABSTRACT

A data visualization and analysis system (“DVAS”) is described, which provides techniques and data models for modeling, storing, retrieving, analyzing, and visually representing large data sets in a rapid, lightweight, flexible, and highly interactive fashion. A data model and various techniques are described with reference to trace data sets, which are files or other data storage constructs used to record information regarding certain defined events occurring during operation of a computing system or a portion thereof. The DVAS receives and parses one or more trace data sets to create a data model that includes a number of layers and other inner or auxiliary data structures. Based on the data model, the DVAS visually renders one or more sets of geometric objects in accordance with different drawing modes. The drawing modes, which are dynamic and interactive, enable users to effectively visually identify patterns within the trace data sets.

### BACKGROUND

Analysis of large data sets, such as trace data sets that include information collected during operation of computing systems, is often complicated by the size and complexity of the data sets. For example, the size of a trace data set including several minutes' worth of information regarding the operation of a computing system, in which a multitude of internal or external hardware, software, and/or firmware components interact, may be as large as, or larger than, several gigabytes.

When large data sets are stored and queried in traditional manners (for example, using multidimensional databases configured for online analytical processing (“OLAP”) querying), various views of the same data set may be built and permanently stored for future user queries, which is often time-consuming and storage-inefficient.

It is desirable to provide efficient, responsive data storage/analysis systems and techniques, which enable a user to interactively visualize relationships, such as patterns or causality, within data of large, sometimes disparate/distinct complex data sets, which relationships may be practically undetectable via examination of the data sets themselves.

### SUMMARY

A data visualization and analysis system (“DVAS”) is described herein, which provides techniques and data models that address various challenges of efficiently storing, manipulating, correlating/retrieving, and interactively presenting information within complex data sets. The DVAS achieves near real-time responsiveness to user input affecting manipulation and presentation of information within one or more complex data sets from one or more sources. For purposes of example and not limitation, both the data models and techniques of the DVAS are described with reference to trace data sets, which are files or other data storage constructs used to record information regarding certain defined events occurring during operation of one or more computing systems (an exemplary computing system is referred to as a “computing system under test”) or portions thereof. Other data sets are possible, however. One example of another possible data set is a set of genome information (human or non-human) based on DNA sequencing activities.

The DVAS is configured to receive and parse one or more trace data sets to create a data model that includes a number of layers and other inner or auxiliary data structures, which are used for storing, retrieving, analyzing, and presenting event information in an abstract and efficient manner.

In accordance with one aspect of the data model, data units are created and associated with particular defined events.

A data unit has a number of associated data structures, which may be explicitly or implicitly defined, and which may be part of the same or different physical or logical constructs. In one exemplary scenario, the associated data structures include a first data structure that is populated with an item of first data representing a particular defined event. A second data structure is populated with an item of second data representing a particular computing system component with which the particular defined event is associated. A third data structure is populated with an item of third data representing a timestamp of the particular defined event. A fourth data structure is populated with one or more items of fourth data representing metrics (which may be created and/or calculated) associated with the particular event, such as duration, start and end times, calling and/or callee data processing operations, display color selections, and the like.

To improve retrieval and/or rendering speed without penalizing main memory, a data unit may be split into two or more parts. In an exemplary implementation, a data unit has two parts. A first part, referred to as a base unit, stores data values on a main memory (for example, a RAM), which are referred to by items of data used during rendering of visual representations (such as data that can be used to derive coordinates of geometric objects). A second part, which in some instances may not be used or present, is referred to as an extended unit. The extended unit stores on a persistent memory those data values that are referred to by items of data that are not used during rendering of a visual representation, although those items of data may be used to retrieve specific user-selected information.

In accordance with another aspect of the data model, various data collections are generated. A particular data collection is a subset of data units that have one or more items of data in common, referred to as “pivot items,” which have pivot types. A metadata data structure may be generated to aggregate the commonalities of the base units and extended units of the data units of a particular data collection.

In accordance with yet another aspect of the data model, one or more data collection sets are generated, either automatically or in response to user input. A particular data collection set groups a subset of data collections that share certain common pivot types. A structured representation of the data collection set, which has a number of nodes (with a particular node corresponding to a unique permutation of the one or more pivot items) may be generated and processed in real-time (for example, in response to user input) to identify one or more data units and/or items of data associated with particular nodes. For each data collection set, a matrix that includes a list of data unit identifiers, such as indices, which are mapped to actual data structure indices, may be created, to facilitate efficient data retrieval, transformation, and presentation.

The DVAS is also configured to efficiently and concurrently visually render one or more sets of geometric objects such as points, rectangles, etc., corresponding to particular data collection sets (from the same or different trace data sets) in accordance with different drawing modes. The drawing modes enable users to effectively identify patterns through visualization. A drawing mode encompasses information such as system axes, coordinate systems, scales, geometries, etc. Each data collection set may include a data structure (referred to as a descriptor) that describes, and enables dynamic changes to, how a particular drawing mode for a particular data collection set relates to the data units and/or data collections associated therewith.

In one exemplary scenario, for a particular data collection set, a particular geometric object is rendered within a coordinate system. A particular geometric object corresponds to a particular data unit associated with a particular node of a particular structured representation of the particular data collection set. The coordinates of the particular geometric object are specified using expressions that have variables as operands (it is noted that a geometric object may be specified by one coordinate, and that a stand-alone variable may constitute an expression). The variables represent items of data of particular data units within the data collection set, and are used to indirectly retrieve data values represented thereby. The expressions that specify the coordinates are evaluated to obtain coordinate values at which a particular geometric object is to be visually rendered. Such indirection enables dynamic switching between coordinate systems and/or data collections sets with little impact on user experience—achieving near real-time responsiveness to user input that affects manipulation and visualization of information. A user is able to identify to interactively visualize relationships, such as patterns or causality, within data of large, sometimes disparate/distinct complex data sets, which relationships may be practically undetectable via examination of the data sets themselves.

Various examples of interactive visualizations of trace data sets and possible uses therefor, as well as certain optimization algorithms, are also discussed herein.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this document.

### BRIEF DESCRIPTION OF THE DRAWINGS

FIG. 1 is a simplified functional block diagram illustrating an exemplary large data set (a trace data set), which has been gathered from a computing system under test by a trace data collection system and which is processed by a data visualization and analysis system.

FIG. 2 is a simplified functional block diagram of aspects of the data visualization and analysis system (“DVAS”) shown in FIG. 1.

FIG. 3 is a simplified functional block diagram illustrating aspects of certain data structures shown in FIG. 2.

FIG. 4 is a simplified functional block diagram illustrating certain techniques implemented by the DVAS shown in FIG. 2 that facilitate transformation of certain event information within the trace data set shown in FIG. 1 into certain visually represented geometric objects.

FIG. 5 is a flowchart of an exemplary method for using aspects of the DVAS shown in FIG. 2 to visually represent occurrences of certain events within a computing system.

FIG. 6 is an exemplary set of user-selectable geometric objects, rendered pursuant to operation of the DVAS shown in FIG. 2, which visually represent occurrences of certain events within a computing system to facilitate perception of recurring patterns that suggest causal relationships.

FIG. 7 is a simplified functional block diagram of an exemplary operating environment in which aspects of the DVAS shown in FIGS. 2 and 4, the data structures shown in FIG. 3, the method shown in FIG., and/or the set of geometric objects shown in FIG. 6 may be implemented or used.

### DETAILED DESCRIPTION

Using the data visualization and analysis system (“DVAS”) and techniques described herein, it is possible to model, store, retrieve, analyze and visually represent large data sets in a fast, lightweight, flexible, and highly interactive fashion. For purposes of example and not limitation, both the data models and techniques of the DVAS are described with reference to trace data sets, which are files or other data storage constructs used to record information regarding certain defined events occurring during operation of an exemplary computing system (referred to as a “computing system under test”) or a portion thereof. Other large data sets are possible, however, such as genome information based on DNA sequencing activities.

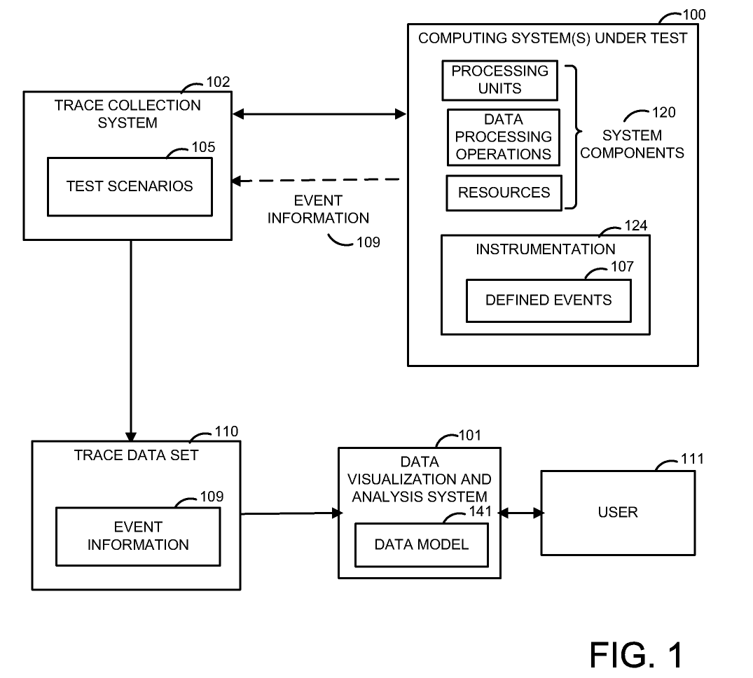

Turning now to the drawings, where like numerals designate like components, FIG. 1 is a simplified functional block diagram illustrating an exemplary trace data set 110, which has been gathered from a computing system under test (“CSUT”) 100 by a trace data collection system 102 and which is received by DVAS 101. Generally, aspects of CSUT 100 are instrumented, via any known or later developed instrumentation 124 and/or instrumentation technique, to provide event information 109 to trace collection system 102 upon the occurrence of certain defined events 107 within one or more computing systems under test (one computing system, CSUT 100, is shown). It will be appreciated that it is possible to devise a wide variety of instrumentation 124 that causes CSUT(s) 100 to provide event information 109, and it is likewise possible for raw trace data set 110 to be organized in any desired manner, such as via a stack, queue, list, file, or database.

Defined events 107 may be specified by trace collection system 102, DVAS 101, and/or user 111, and represent occurrences or activities within CSUT 100. Such occurrences or activities may be single occurrences or activities represented by event information 109, or may be aggregations of occurrences or activities represented by event information 109, which are interpreted and/or defined to have certain meanings. As such, it will be appreciated that virtually unlimited numbers and types of events may be defined. Exemplary event information 109 associated with defined events 107 includes but is not limited to caller/callee processing unit and/or data processing operation; resource identification; start/entry time; end/exit time; or execution/access times.

CSUT 100 may include various system components 120, such as one or more processing units in one or more locations (a processing unit may be any processing construct now known or later developed, including but not limited to a CPU, GPU, core, or hardware thread); one or more data processing operations (including but not limited to processes, software threads, or service-providing entities exposed thereby), which are executable by one or more of the processing units to provide certain functionality; and various internal or external resources, including but not limited to files, data, computer-readable storage media, registry keys, objects, and the like, which are accessible via the processes. Examples of defined events 107 include but are not limited to activities related to certain processing units, calls to/from certain data processing operations, and resource access activities.

Trace data collection system 102 represents any known or later developed hardware, software, firmware, or combination thereof deployed to execute certain test scenarios 105 during operation of CSUT 100 to produce trace data set 110. Trace data set 110 includes any event information 109 gathered pursuant to execution of one or more test scenarios 105.

Based on trace data set 110, aspects of DVAS 101 create a data model 141 which, when processed in accordance with the techniques described herein, visually and interactively represents the occurrences of defined events 107 within CSUT 100 to a user 111.

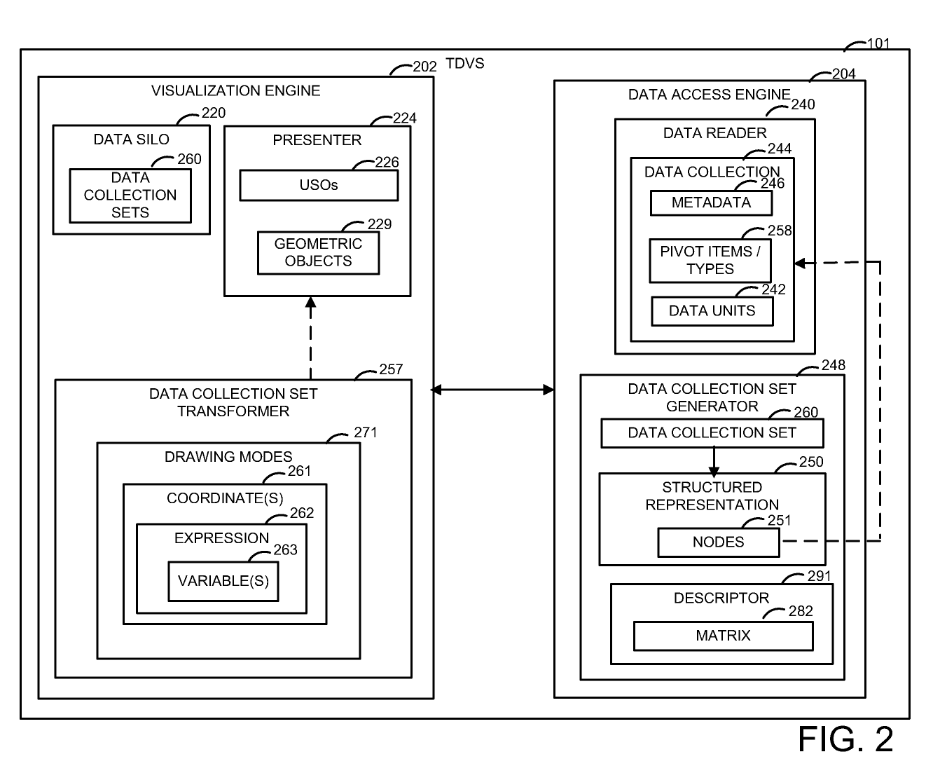

With continuing reference to FIG. 1, FIG. 2 is a simplified functional block diagram of aspects of DVAS 101. The architecture of DVAS 101 is flexible, and in general, design choices and/or operating environments dictate how and whether specific functions of DVAS 101 are implemented. Such functions may be implemented using hardware, software, firmware, or combinations thereof. Particular configurations of DVAS 101 may include fewer, more, or different components than those described.

In an exemplary implementation, DVAS 101 includes: a data access engine 204, which is responsible for creating aspects of data model 141 based on trace data set 110; and a visualization engine 202, which is responsible for visually representing defined events 107 based on data model 141. In one exemplary scenario, multiple data access engines 204 (or portions thereof) may be implemented as plug-ins to visualization engine 204. As discussed further below, various declaratory language data structures are created and/or used by DVAS 101. Any known or later developed schemas or base templates (not shown) to which the syntax of the data structures may conform, can be used to facilitate organization and interpretation of such data structures. For example, various schemas are available and/or definable for XML, although it will be appreciated that any declarative programming language may be used.

In connection with the functionality of data access engine 204, data reader 240 receives and parses trace data set 110. Data reader 240 is responsible for classification, filtering, and aggregation of event information 109 to implicitly or explicitly populate data units 242 with items of data, and for extracting the commonalities of data units 242 to form data collections 244.

Data units 242 are sets of declaratory language data structures associated with particular defined events 107. A particular data unit 242 is associated with a particular defined event 107, or an aggregation of defined events. As discussed above, a particular defined event 107 may be described by one or more units of event information 109 recorded within trace data set 110.

The data structures associated with data unit 242 may be part of one or more physical or logical constructs, and are implicitly or explicitly populated with items of data representing data values stored in one or more computer-readable storage media. Such items of data may be any direct or indirect references, such as one or more strings, numeric values, variables, pointers, vectors, or URLs.

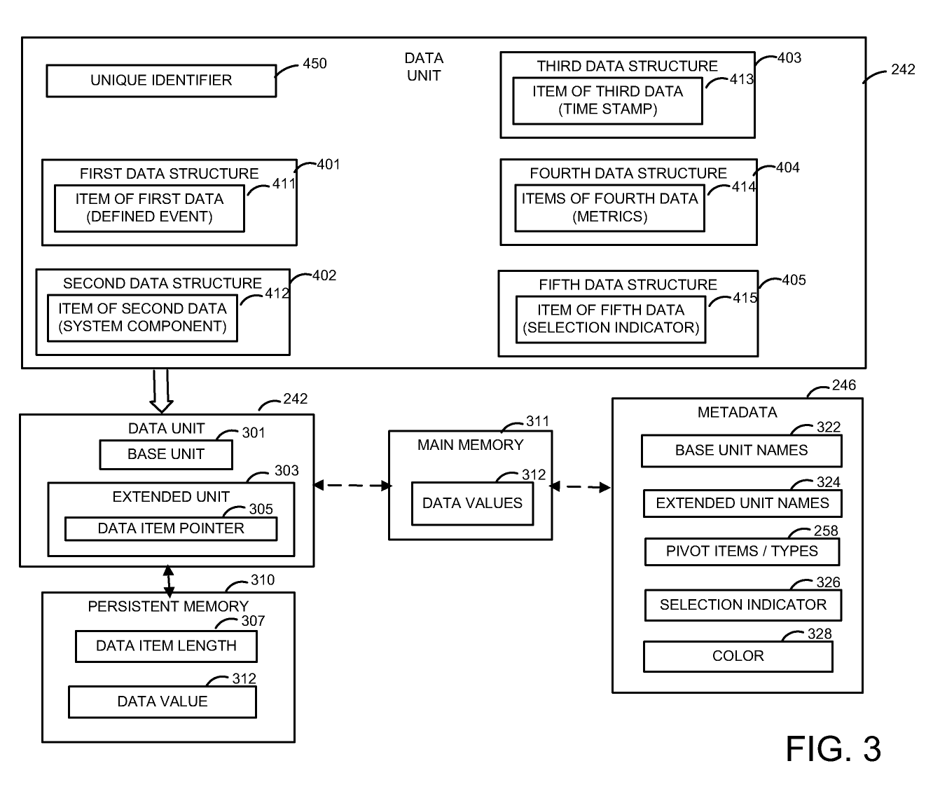

Turning briefly to FIG. 3 before returning to the discussion of FIG. 2, FIG. 3 is a simplified functional block diagram illustrating an exemplary logical configuration of a data unit 242 (including its associated data structures and items of data stored thereby), and also illustrating an exemplary metadata data structure 246 (discussed further below). It is noted that a particular data unit 242 is identified by a unique identifier 450, such as an index, to facilitate indirect and efficient retrieval of information stored by the particular data unit.

A first data structure 401 associated with data unit 242 is populated with one or more items of first data 411, which represent a particular defined event 107 and/or type thereof. In one possible implementation, first data structure 401 is part of metadata data structure 246.

A second data structure 402 is populated with one or more items of second data 412, which represent particular computing system components 120 and/or types thereof with which the particular defined event is associated. In one possible implementation, second data structure 401 is part of metadata data structure 246.

A third data structure 403 is populated with an item of third data 413, which represents a timestamp of the particular defined event. The timestamp may be any desired time associated with occurrence of the particular defined event, such as the start time, end time, a time value calculated or derived from start and/or end times (a duration, for example), or a time value calculated or derived from other event information 109. It is also noted that in addition to or instead of time, one or more other dimensions or constructs may be used to establish a relative sequence between data units.

A fourth data structure 404 is populated with one or more items of fourth data 414, which represent metrics associated with the particular defined event. In one possible implementation, items of fourth data are expressed as an array. Examples of metrics include but are not limited to: a reason/source for a particular defined event; a start time; an end time; a callee data processing operation identifier; a caller data processing operation identifier; a start address or other information associated with a particular caller or callee data processing operation; and a duration. It will be appreciated, however, that many additional metrics are possible. It will also be appreciated that certain metrics may be calculated or derived based on other event information 109 within trace data set 110.

A fifth data structure 405 is optionally populated with one or more items of fifth data 415, which indicate whether the particular defined event represented by the data unit itself and/or any aspect of the particular defined event represented by any items of data are selected for visual representation to a user based on current user selections (user selections are discussed further below).

Data units 242 optionally have two or more parts. Splitting the data structure into multiple parts improves the speed of the visualization engine without penalizing the main memory. In one exemplary implementation, data units have two parts. The first part, referred to as a “base unit” 301, may be stored in a main memory 311, which is generally a non-persistent memory such as a RAM. Base unit 301 stores information that is used to render visual representations, such as data that can be used to derive coordinates of geometric objects 229 (discussed further below) and data that can be used to render other aspects of drawing modes 271 (also discussed further below) to a user. The second part, which may not be present for all data units, is referred to as an “extended unit” 303. Extended unit 303 has a data item pointer 305 used to retrieve data values 312 and data items lengths 307 from secondary storage, which is generally a persistent memory location 310. Extended unit 303 stores information that is not used during rendering of visual representations, but may be used to retrieve specific user-selected information.

Metadata data structure 246 includes a number of sub-data structures, which aggregate commonalities of the base units and the extended units for the sub-set of data units forming a particular data collection 244 (discussed further below). In this manner, the metadata data structure helps to reduce the amount of data stored in the main memory. Examples of sub-data structures composing the metadata data structures include but are not limited to: pivot items/types 258 (discussed further below); friendly names of the data on the base units (base unit names 322); friendly names of the data on the extended units (extended unit names 324); and other items of information about a state and/or status of a property associated with particular data units and/or data collections, such as selection indicators 326 and color indicators 328.

Referring again to FIG. 2, a data collection 244 (one shown, multiple are possible) is a sub-set of data units 242 having one or more data items in common, which are referred to as pivot items 258. Pivot items 258 specify common items of data between the data units of the data collection, upon which information in the data collection may be pivoted (in one possible implementation, pivot items and/or types are expressed as an array of labels, with each item in the array defining a node—one or more data units—within a representation of the data units forming the data collection.) Pivot items/types 258 are shown as being separate from metadata data structure 246 for discussion purposes. It is possible, however, for pivot items/types 258 to be included as part of metadata data structure 246 or another data structure. Pivot types represent types of commonalities used for further classification, filtering, and aggregation purposes. Examples of pivot types include but are not limited to event types, system component types, and data value types (such as data types or measurement units).

A data collection set generator 248 generates sub-sets of data collections having pivot items 258 of the same type, referred to as data collections sets 260. Data collection sets 260 may be pre-generated or generated in response to user selections. For example, different views of the same data may be generated, such as distinct data collection sets for bus operations, core operations, and transfer speeds of CSUT 100. In addition, more than one data collection set (from more than one trace data set) may be processed concurrently.

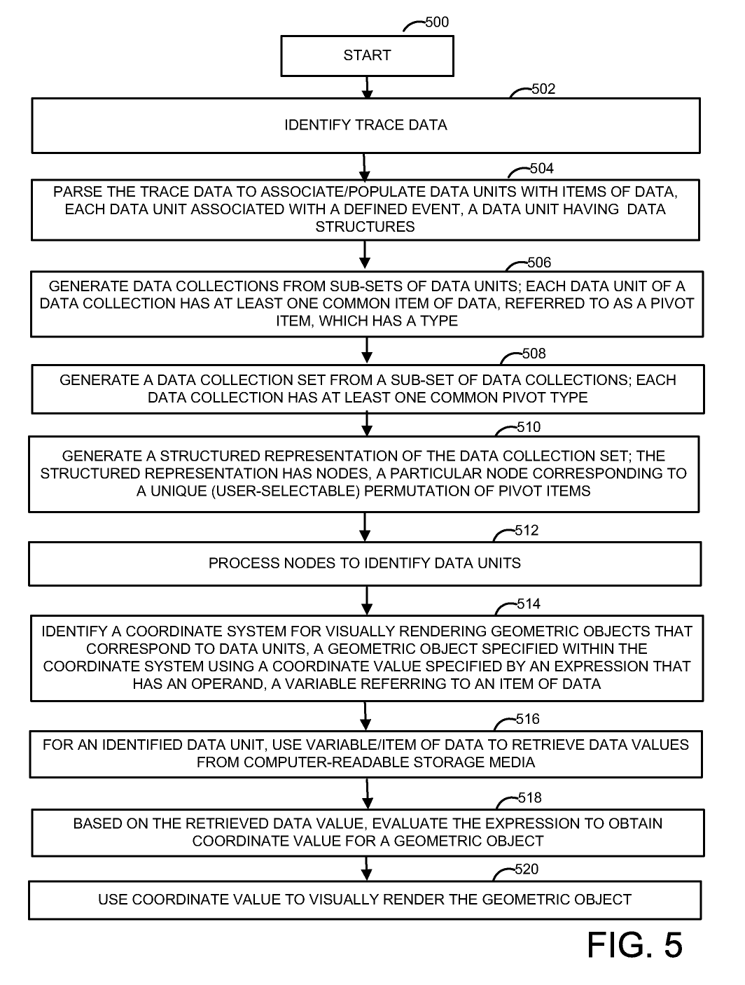

An arrangement of data collection sets 260 is referred to as a data silo 220. A data silo 220 is an aggregation of data collection sets 260 from a given trace data set 110 or designated amount of data from a given trace data set 110. It also encapsulates other “silo wide” capabilities, such as skew and offset, that facilitate synchronizations between traces (such silo-wide capabilities are discussed in examples further below, following the discussion of FIG. 5).

One or more structured representations 250 may be generated based on a particular data collection set 260. A structured representation is generally created based on processing of one or more declarative language instructions, and may include different nodes corresponding to different data collections 244. In an exemplary scenario, a structured representation includes nodes 251 based on unique, user-selectable permutations of pivot items 258 of the data collections 244 of a particular data collection set 260. User input may be used to re-order a data collection set representation based on a different ordering of pivot items 258. Nodes 251 of structured representation 250 are be processed (queried, for example, using any known or later developed query language or technique) to identify one or more data units 242 associated with each processed node.

A descriptor data structure 291 includes information such as the different drawing modes 271 (discussed further below) that are associated with a particular data collection set 260, and/or information that facilitates indirect retrieval of items of data from the data units of the data collections. For example, a matrix 282 may be included within descriptor data structure 291, and be invoked (for example, by visualization engine 202, which discussed further below) to indirectly retrieve stored data values for data units 242 associated with particular nodes 251 of a particular structured representation 250. In one possible implementation, matrix 282 is an index-to-label matrix populated with desired labels expressing pivot items/types 258 and/or other items of data used to determine associated data unit data structures (or vice versa), including but not limited to unique identifiers 450, first data structure 401, second data structure 402, third data structure 403, fourth data structure 404, or fifth data structure 405.

As shown, visualization engine 202, which is responsible for visually representing defined events 107 based on data model 141, includes a data collection set transformer 257 and a presenter 224, although it will be appreciated that more, fewer, or different components are possible.

Data collection set transformer 257 is responsible for transforming information regarding defined events 107 associated with data units 242 of one or more data collection sets 260—associated with one or more data silos 220—into data that defines, among other things, coordinates for a set of geometric objects 229 (such as points, rectangles, etc.) for each data collection set 260 in accordance with a particular drawing mode 271. A particular data collection set 260 is generally bound (in an exemplary implementation, via descriptor data structure 291) to one or more drawing modes 271. Data collection set transformer 257 (or another aspect of visualization engine 204) may also be responsible for validating information provided by data access engine 204 for legal syntax against one or more schemas and/or templates.

A particular drawing mode 271 encompasses information such as system axes, coordinate systems, scales, geometries, etc. used for rendering visual information associated with a particular data collection set 260, including but not limited to geometric objects 229 (discussed further below) and user-selectable objects (“USOs”) 226 (also discussed further below), to a user. Presenter 224 is responsible for visually representing aspects of a particular drawing mode 271 to a user.

In one exemplary scenario, for a particular data collection set 260, a particular set of n-dimensional geometric objects 229 is rendered in an n-dimensional space/coordinate system based on coordinates 261 having derived by data collection set transformer 257. A particular geometric object 229 corresponds to a particular data unit 242 associated with a particular node 251 of a particular structured representation 250 of a particular data collection set 260. Examples of geometric objects include but are not limited to points, rectangles, volumes, lines, curves, charts, etc.

For a particular drawing mode 271, coordinates 261 of a particular geometric object 229 are specified using one or more expressions 262 that have one or more variables 263 as operands. It is noted that a geometric object may have a single coordinate, and that a stand-alone variable may constitute an expression. Variables 263 represent items of data 411, 412, 413, 414, 415 of particular data units 242 within a data collection set 260, and the variables are used to indirectly retrieve data values 312 represented thereby. A particular data collection set 260 is generally bound to a particular matrix 282, which may be invoked to indirectly retrieve data values 312 from appropriate computer-readable storage media 310/311.

Once data values 312 have been retrieved, expressions 262 are evaluated to obtain coordinate values at which a particular geometric object 229 is to be visually rendered. Such indirection enables dynamic switching between drawing modes/coordinate systems, data silos, data collection sets, and/or data collections with little impact on user experience—achieving near real-time responsiveness to user input that affects manipulation and visualization of information. Moreover, visual representations need not be pre-created and stored for future user queries—they may be created and changed on-the-fly.

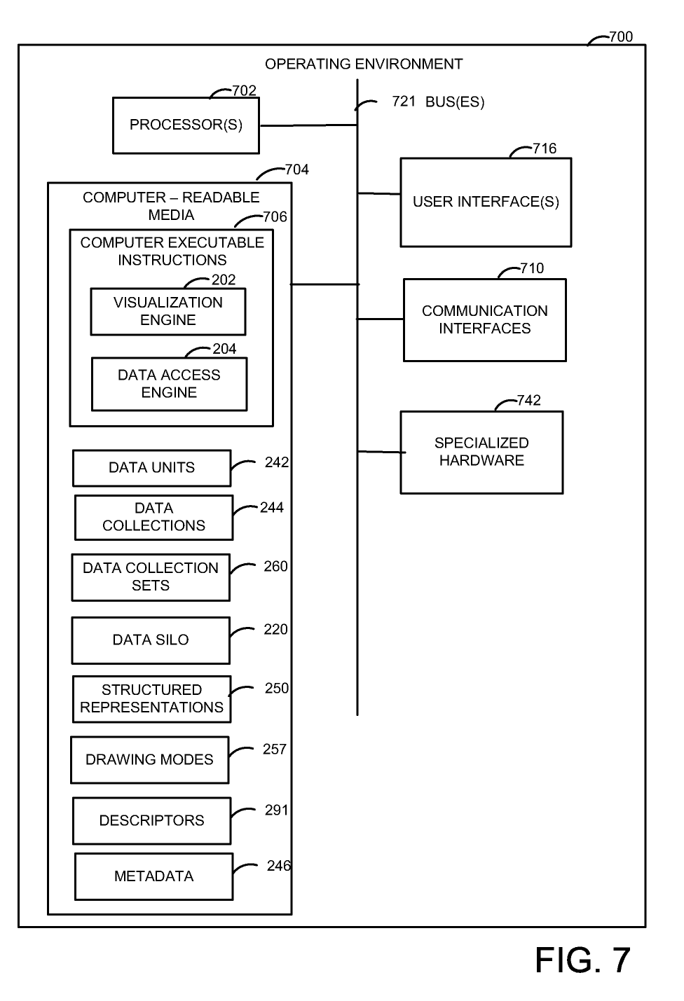

In one exemplary scenario, user input is received via user selectable objects (“USOs”) 226. USOs 226 represent presentation tools or controls in the form of visible objects presented via a user interface (a user interface 716 is shown and discussed further below, in connection with FIG. 7), such as graphics, images, text, video clips, and the like. Such visible objects may generally be any visible information (such as system axes, coordinate systems, scales, geometric objects, etc.) associated with a particular data collection set 260. One or more items of data from data units 242 may be used to present or access USOs 226, such as selection indicators 326, colors 328, etc.

USOs 226 are selectable to access interactive functionality of DVAS 101. Examples of interactive functionality of DVAS 101 include but are not limited to: dynamic switching between drawing modes/coordinate systems, data silos, data collection sets, and/or data collections; navigating sets of geometric objects to view and/or toggle between different selections; enabling/disabling synchronization between contents of the presentations of different sets of geometric objects; selecting/changing the way in which the same data is visualized (e.g., changing the permutation order of the nodes of a representation of a particular data collection set); selecting/changing the perceptual enhancements (e.g., highlighting, color schemes, etc.) of selected and/or unselected geometric objects within various drawing modes; and dynamically highlighting and presenting detailed event information 109 within trace data set 110 pursuant to certain user input, such as hovering over certain geometric objects.

It will be appreciated that numerous, virtually unlimited, data collection sets 260 and/or drawing modes 271 therefor can be devised for a particular data silo 220, enabling the rapid, responsive, and efficient visualization of performance of one or more CSUTs 100 or components thereof in a manner that would be too difficult, impractical, or complex to accomplish with reference to raw trace data sets 110.

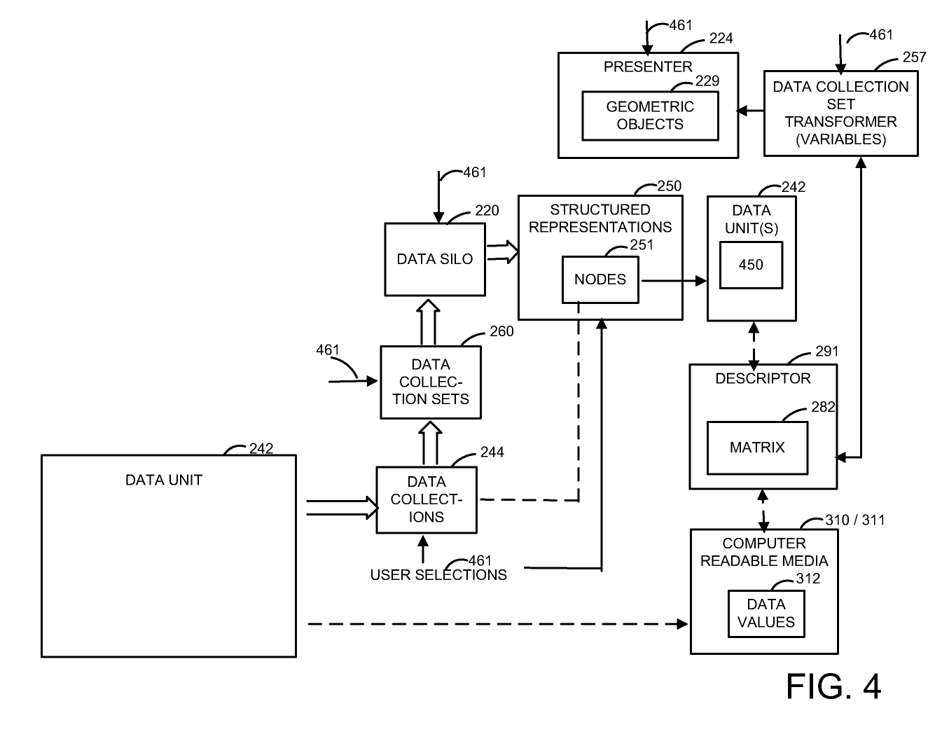

FIG. 4 is a simplified functional block diagram illustrating certain functional aspects of the operation of DVAS 101 that were discussed in connection with FIGS. 2 and 3. Exemplary points at which user selections 461 may be received (via USOs 226, for example) and used to provide highly interactive visualization of defined events 107 associated with particular data units 242 are also illustrated.

With continuing reference to FIGS. 1-4, FIG. 5 is a flowchart of an exemplary method for using aspects of DVAS 101 to visually represent occurrences of certain defined events, such as defined events 107, within a computing system, such as CSUT 100. The method illustrated in FIG. 5 may be implemented by computer-executable instructions, such as computer-executable instructions associated with data access engine 204 and visualization engine 202, which are stored in a computer-readable medium 704 and executed by one or more general, multi-purpose, or single-purpose processors, such as processor 702. Unless specifically stated, the methods or steps thereof are not constrained to a particular order or sequence. In addition, some of the methods or steps thereof can occur or be performed concurrently. The method illustrated in FIG. 5 is initially described in general terms. Various exemplary visualizations, uses, and optimizations are described in more detail following the discussion of the flowchart.

The method begins at block 500, and continues at block 502, where trace data, such as trace data set 110, is identified.

Next, at block 504, the trace data is parsed (by one or more data readers 240, for example) to implicitly or explicitly populate a plurality of data units, such as data units 242, with items of data, such as items of data 411, 412, 413, 414 and optionally 415. Each data unit is associated with a particular defined event 107 and has a number of data structures associated therewith (such as data structures 401, 402, 403, 404, and optionally 405), which are populated with corresponding items of data. The data structures associated with a particular data unit 242 may be part of the same or different physical or logical constructs.

At block 506, data collections, such as data collections 244, are generated from sub-sets of data units. Each data unit of a data collection has at least one common item of data, referred to as a pivot item, and each pivot item has a pivot type (for example, pivot items/types 258).

A data collection set, such as data collection set 260, is generated, as indicated at block 508. A data collection set includes a sub-set of data collections, each data collection having at least one pivot type in common, such as an event type, component type, or data value type.

At block 510, one or more structured representations of the data collection set, such structured representations 250, are generated. A structured representation has nodes, and a particular node corresponds to a particular data collection-that is, a particular unique (and generally user-selectable) permutation of pivot items/types 258. As indicated at block 512, at least some of the nodes are processed to identify one or more data units associated with each processed node.

At block 514, a coordinate system, such as coordinate(s) 261, which is generally associated with a particular drawing mode 271, is identified for visually rendering geometric objects, such as geometric objects 229, which correspond to the identified data units. In one exemplary implementation, a data structure, such as descriptor 291, includes information regarding the relationship between different data collection sets 260 and drawing modes 271.

A particular geometric object is specified within the coordinate system using at least one coordinate value, such as a coordinate value 261, which is specified by an expression, such as an expression 262, having an operand in the form of a variable, such as a variable 263, which represents an item of data of a particular identified data unit. In one exemplary implementation, the variable represents the item of third data, representing the timestamp of the particular identified data unit. Other coordinate values may be specified by other expressions that have one or more operands in the form of variables used to indirectly retrieve data values represented by items of data of particular data units. For example, such expressions may have variable operands representing one or more items of fourth data—that is, one or more metrics associated with a particular data unit.

As indicated at block 516, for a particular identified data unit, the variable is used to indirectly retrieve, from a computer-readable storage medium (such as persistent memory 310 or main memory 311), a particular data value, such as a data value 312, associated with the particular item of data represented by the variable 263. In one exemplary implementation, a matrix, such as matrix 282, is used to indirectly retrieve stored data values for particular data units.

The expression is evaluated based on the retrieved data value, to obtain the coordinate value for the particular geometric object, as indicated at block 518, and the coordinate value is used to visually render the geometric object, as indicated at block 520.

As an example, assume that there is an “interval tick” drawing mode available for a particular data collection set 260, which specifies a 2-dimensional coordinate system in which rectangles having coordinates (X, Y, X+W, Y+H) are rendered. The following is a description, in pseudo-code form, of an exemplary interval tick drawing mode:

Interval Tick {DefaultHighlight, H(P1), W (P0)}, where P0 represents an item of data (for example, a metric such as duration) for a particular data unit 242 of a data collection set, and P1 is a fixed value (such as “1”) used to represent a particular data processing operation.

To visually render a rectangle for a particular data unit/event of the data collection set, visualization engine 204 invokes descriptor 291 associated with the particular data collection set, to indirectly retrieve data values described in the interval tick drawing mode. Once the data values are fetched from the data units, the data values may be used to draw a rectangle having coordinates (X, Y, X+W, Y+H), which results in a rectangle with a fixed height corresponding to the fixed value, and a width corresponding to the metric (for example, duration).

The method illustrated in FIG. 5 may be used to produce various types of interactive visualizations of trace data sets, and certain optimization algorithms may also be applied. Certain exemplary drawing modes, uses, and optimizations are discussed below.

Multi-System Trace Visualization Synchronization of System Wide Activity

In distributed computing environments, users need tools to derive correlations of events that happened on different systems, for example in different computers or networks. Synchronization of such events becomes a problem due to different technological challenges intrinsic to the diverse and sparse environments, such as clock skews, precision, event alignment, etc.

These problems may be solved via aspects of DVAS 101. In one exemplary implementation, a sequence of primitives may be applied to the original (raw) trace data, detecting the problems and “fixing” them by approximation. To accomplish this, the following techniques may be applied: determine a defined event on each source that can be correlated to; make that event the “reference event” relative to each source; align every source by the reference event (t=0); determine a “stop event” on each source and make them also “reference events”.

Due to clock skews and event resolution mismatches, it is very likely that each segment on each data source, determined by the start and stop reference events, will not match in size. Therefore the segments may have to be scaled and aligned to match in size. Any known or later developed skewing algorithms may be used to accomplish this.

Different approaches may be used to determined the reference. The determinations may be user-driven (that is, a user chooses the points) or automatically inferred. To automatically infer the points a reliable synchronization event can be identified on each source (e.g. a timestamp event) so the system can attempt to match them.

The heartbeat approach is another way to increase the reliability of the segment detection. From time to time, the systems will generally log a particular (heartbeat) event, and that event can be used to align the segments. The higher the heartbeat frequency, the higher the alignment precision will be.

Sparse Layered Representation of System Wide Activity

Users desire to have tools to visually recognize patterns of system activity and causality. It is a very common problem in performance optimization to find patterns that are not done in the optimal case, especially if those patterns are executed many times.

For example, the user is suspicious that the application is abusing on registry use. He needs tools to investigate when (how often) and how (which operations) were performed. He needs to be able to identify those recurring patterns easily (assuming he is correct in his suspicion, the application will be definitely accessing the registry heavily).

In one possible implementation, each registry key may be represented by a different color, and in a different position in the Y axis. The recurring patterns become readily visually apparent, reducing dramatically the amount of time necessary to find performance issues.

Causality is something that can be inferred by this approach as well. By stacking the operations rooted on the execution timeline, aggregated with a unique representation of the operation, if that operation repeats itself they will show in the same order to the user. The sparse layered representation includes a visual representation of hierarchal (tree representation) data on a timeline, where each event instance of a leaf node of the tree is assigned an (X, Y) coordinate in a visual display. The X coordinate corresponds to the event (data unit) timestamp. The Y coordinate represents the count of unique leaf nodes found up to a given point in time in the X coordinate. Such that, once an event that establishes a new leaf node is found, a Y coordinate of the total count of “unique leafs+1” is assigned to that leaf, and all subsequent events from that same leaf will be presented in the same Y coordinate. Such sparse representation enables the visualization and facilitates the perception of reoccurrence patterns which may indicate a causality relation between events that occurs at a given approximate order and visual representation proximity.

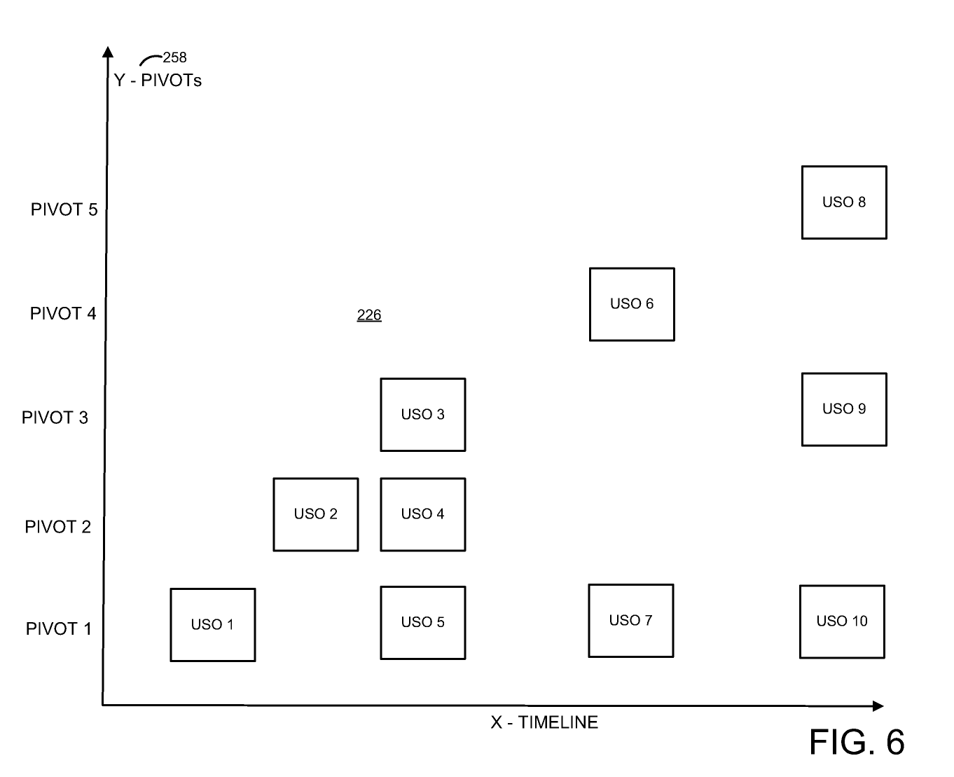

FIG. 6 is an exemplary set of geometric objects (rectangles, points, etc.) in the form of USOs 226, rendered pursuant to operation of a “Sparse Layered Representation” drawing mode as described above. It can be seen that occurrences of certain events (associated with certain pivot items 282) within a particular computing system are visually represented in a manner that facilitates perception of recurring patterns that suggest causal relationships.

Multi-Dimensional Axis Synchronization of System Wide Activity Visual Representation of Trace Data

In complex environments users will be dealing with many different data collection sets and/or drawing modes and attempting to correlate them. The more complex the environment, the harder it is for the user to keep track of the visual representations. Using DVAS 101, it is possible to synchronize the contents of the X, Y or X+Y axes. In other words, when a user pans a view to the right, all related content (and only the related content) will follow suit. The same applies to the Y axis. The user may also combine different views and synchronize only in one of the axis, e.g. X. That means that even two 2D graphs can be synchronized, say, by time.

To accomplish this an array of index types may be defined, that define what kind of data each axis holds. The drawing mode provides the mapping between the actual values and the “units” they represent. If the units match as well the axis, they can be kept track of together. That means if the user applies a zoom, pan, or any other operation that changes the coordinate system (or other aspects of what the user sees), it can be propagated to all other drawing modes currently being displayed, affecting them as well.

Another advantage of this approach is the ability to correlate different data sets on key variables. For example, if the user opens a “Registry Usage” view (that shows which keys are being used) at the same time he opens “Process and Threads”, as both are synchronized by time, by focusing on the key he is looking for the other window will shift and display what process is accessing that key at that very same time. All is done automatically and in real time.

Exceptions to this approach may also be defined, and the user may enable/disable them as desired. For example, a user can open two views of “Process and Threads” and view different sections of the process activity. If the modes above are in effect, when he scrolls one of them, the other can be detached and the user can navigate freely.

Bi-Directional Manipulation of System Wide Trace Data and Trace Visual Representation

This exemplary implementation allows a user to view neighbor events on the system, by selecting a target event on the screen. The user may also specify how wide his search is, in other words, how far from the target his correlations will span. To accomplish this, data collections are traversed and items of data that match the user's criteria are found and highlighted, as well as being displayed in a textual table. Note that highlight is just one of the many possible ways of displaying the results. It is also possible to toggle from the textual representation to the “wide search” results. For example, “Next >” and “<Back” arrows may be enabled in the textual representation and at the same time updating the highlights on-the-fly.

The following is an exemplary algorithm for syncing textual and graphical representation, in pseudo-code form:

```
Parameters = { SearchMaxResults, Mouse.X }
Results = { List-Before, Target, List-After }
List-Size = SearchMaxResults / 2
Empty ( Results )
For Each (DataCollection d in DataCollections)
  // Add the target node to the results
  potentialTarget = Get-Nearest-OrUp(Mouse.X, d)
  If ( potentialTarget.X < target.X )
    // Our new target is better, move old target to higher
    Add-To-Sorted-List(List-After, target, List-Size)
    Target = potentialTarget
  Else
    // It is just an ordinary target
    Add-To-Sorted-List(List-After, potentialTarget, List-Size)
  // Add events before the target
  count = SearchMaxResults / 2
  event = d [target − 1]
  While ( count > 0 )
    Add-To-Sorted-List(List-Before, event, List-Size)
    count = count − 1
  // Add events after the target
  count = SearchMaxResults / 2
  event = d [ target + 1 ]
  While ( count > 0 )
    Add-To-Sorted-List(List-After, event, List-Size)
    count = count − 1
Function Add-To-Sorted-List (List, Item, MaxSize)
  // This function adds the item to the list, keeping
  // the list sorted and “dropping” items that do not fit
  // the list anymore if the new incoming item is a better
  // match, keeping the list always at MaxSize
```

Multi-Pivoting Hierarchical Aggregation and Manipulation of Distinct System Activity Representation that Share Common Properties

A user will often desire to correlate diverse data without building complex indexing schemes or pre-processing the answers. In many cases, the same data can be viewed from many different angles. For example, for a list of processes and registry key access, a user could ask:

Q1: “What registry keys process P accessed?”

Q2: “What processes accessed registry key K?”

DVAS 101 provides the ability to pivot data collection sets based on different permutations of pivot items and/or types. The following technique may be used: in the metadata data structure an array of labels is defined, with each item of the array defining a node that represents the level in the hierarchy. A list of possible pivot items (list of labels) is provided, as well as what indexes are used to build the tree. Alternatively, the generation of the list of possible pivots can be done automatically, by creating all or a subset of the permutations. When the user selects a new pivot representation, the hierarchical view of the item of the array may be cleaned, and the matrix 282 may be used to rebuild the tree by inquiring the data collection about each of the labels following the order defined in the index list. If an item is not there, it can be added as a new level of the tree, and if an item is there, it can be added to the existing parent determined by the previous label index. Once the tree is built for each node, all data collections may be aggregated to that level if they have the same path. That way all items on the leaf node will be left at the same level

In the exemplary questions Q1 and Q2 above, consider a “Registry per Process” data collection set. The data collection set is built with the following labels: (a) Process, (b) Key and (c) Operation. A default view may show all the processes, and it is possible to dive into the process details of what registry keys it operated on, answering question Q1, accomplished by passing the label index list as [0, 1, 2]. To be able to see what processes operated on a specific key, by passing the label index list as [1, 0, 2], a new tree will be built with the Key as the top level item. That will answer Q2.

Perceptual Enhancement of Selection Highlighting for High Density System Activity Data Representation Graphs

Oftentimes users attempt to infer new conclusions about problems where the root cause is unknown. To aid the user to understand what find of data is being handled, DVAS 101 enables matching selections and visual representations of the data.

When the user is analyzing an ordinary computing system, he will be dealing with many different components, such as processes, threads, registry keys, interrupts, etc. To make it more challenging all this information can be displayed at the same time in the various visual representations the user is dealing with. It is possible to filter the data the user is interested in, but often unselected data also stays in the visual representations. Different color schemes may be used to represent the selected and unselected data points. That allows a user not just to visualize his data but also compare against other data that is not filtered. For example, if a user selects to see where a process executed, he can compare this against all the other processes and see how much this process is interfering with the others or vice-versa. Note that selecting a process is just an example. This principle should allow the user to select various data points, tag them, chose the display modes, compare strategies, etc.

Dynamic Visual Highlighting and Presentation of Detailed Information During Mouse Hover for High Density System Activity Data Representation Graphs

Once a user spots a point in a visual representation that he is interested in, he may want to receive extra details about the segment he is looking at. That problem gets complicated due to not just the density of the data, but also the disparity (diversity) of the data being attempted to be detailed.

For example, when stopping over a visual representation of a process, a user wants more information about that process at only that specific point in time. He may wants to see the global process information such as process ID, name, etc., but more importantly he wants to see what the process is doing at that instant in time. Some useful information that can be retrieved and displayed for this example would be: (a) date/time process was scheduled to run at this round; (b) what priority did the process get into the processor; (c) what is the process doing; (c.1) what module is running; (c.2) what call stack and so on and so forth; (d) how much memory is allocated at that time; etc.

DVAS 101 is able to retrieve and present this data in a very efficient and generic way, including retrieving some information from base units 301 and possibly from extended units 303, allowing different drawing modes to bring different data upon user request.

Segment Resource Usage Representation Over a Timeline

There are certain resources (for example, scarce resources) that are formally allocated to be available by the processes to be used. Resources like RAM, disk storage are common examples yet not inclusive list of such resources. A common problem users face is that resources are allocated and not freed, resulting in defects referred to as “leaks.” For memory, for instance, these defects are commonly referred as “memory leaks.”

Tracking scarce resources may be important for analyzing problems resulting from leaks. The user may want to know when the resource was allocated, when it should have been freed, when it was actually freed (if ever freed), and so on. DVAS 101 enables this problem to be solved in an effective and visually compelling way to make the resource usage readily apparent.

In one exemplary implementation, the concept of a “heat map” was used, where resources are plotted on a two-dimensional matrix—for example, for memory the column X would represent the memory bank, Y represents the memory address within the bank, and the coordinate [X, Y] would represent the allocation of that memory block. For example, by having [X, Y] be a bit, when set would mean allocated and not set mean free. It will be appreciated that the map being represented by a bit is just one possibility. Virtually any data structure may be referred by the matrix.

Snapshots of the heat map are taken for each unit of time, producing many heat maps indexed over time, and a 3D structure that represents the actual allocation over time can be created. Another possibility would be to create a “stream” version of the data that could be played so that a user could see the evolution over time. The user, however, may not be able to easily spot differences over long periods of time. One possible approach is to apply a transformation over the two-dimensional structure to create a one-dimensional structure (or transform a three-dimensional structure to create a two-dimensional structure), which is easier to visualize. The transformed structure may be rendered as a regular data collection set without the need of any special processing and any correlation tools of DVAS 101 may be used.

Referring to the memory representation example above, instead of representing the memory as (bank, relative-address) in the two-dimensional structure, the memory layout may be flattened in accordance with the following pseudo-code, converting it into (absolute-address) [or “relative enough” address]: Mem(Bank, RelativeAddress) [symbol] Mem(AbsoluteAddress); Mem(Time, Bank, RelativeAddress) [symbol] Mem(Time, AbsoluteAddress).

Optimization Algorithms

Multi-System Trace Alignment and Skew Optimization

When implementing the approach to align different trace data sets, either from different CSUTs or different logs of the same CSUT, the near real-time mapping of data may pose challenges. In one exemplary implementation, data conversions/transformations are only performed for the segments that will be visible by the user, to reduce computations. For example, if the user wants to see events from [1000, 2000], by reverting and converting the viewport to a set of world coordinates, the translation of the original data may be accomplished by just translating the viewport.

Similarly, when it is determined (by the system and/or user) that one system is slipped or skewed by a factor, that transformation may be applied to the system's viewport. Once the new viewport is calculated, all the transformations to “match” the events can happen automatically.

High Density System Activity Visual Representation Drawing Optimization

When drawing data of large segments, many “collisions” of data will happen. That means that although the events are not that close to each other in time, they may appear to be on the display. The amount of computation may be reduced by finding those collisions and removing them.

The following algorithms, presented in pseudo-code form, filter these collisions and increase the performance of DVAS 101. For each, the optimizations the drawing mode varies on X and Y where X is the width and Y is the height of the screen.

Point Optimization

```
Alloc bit field {X*Y/8} (linearizing the 2d screen)
Initialize all with 0s
Before drawing check if the bit
BOOL TestAndSetBitAt( int x, int y )
{
  If ( x/8 >= m_nX || x/8 < 0 || y >= m_nY || y<0 )
    return FALSE;
  unsigned char &cell= m_pField[ y*m_nX + ( x / 8 ) ];
  unsigned char mask = 0x1 << ( x % 8 );
  BOOL retval = ( (cell & mask) != 0 );
  cell |= mask;
  return retval;
}
If the bit is set don't draw
If the bit is not set draw and set the bit
```

Simple Tick Optimization

```
Alloc bit field {X/8} (since they are tics we don't care about Y)
Initialize all with 0s
Before drawing check if the bit
BOOL TestAndSetBitAt( int x, int y )
{
  if( x/8 >= m_nX || x/8 < 0 )
    return FALSE;
  unsigned char &cell= m_pField[ ( x / 8 ) ];
  unsigned char mask = 0x1 << ( x % 8 );
  BOOL retval = ( (cell & mask) != 0 );
  cell |= mask;
  return retval;
}
If the bit is set don't draw
If the bit is not set draw and set the bit
```

Bar Optimization

```
Alloc bit field {X} (since they are tics we care about Y as height)
Initialize all with 0s
Before drawing check if the bit
BOOL TestAndSetBitAt( int x, int y )
{
  if( x >= m_nX )
    return FALSE;
  unsigned char cell= m_pField[ x ];
  return cell < y;
}
If test = false
  don't draw
else
  draw
  set m_pField [ x ] = y
```

Bar Bi-Directional Optimization

```
Alloc 2 bit fields {X} (since they are tics we care about Y as height)
              (one bit field up and one is down)
Initialize all with 0s
Before drawing check if the bit
BOOL TestAndSetBitAt( int x, int y )
{
  if( x >= m_nX )
    return FALSE;
  unsigned char cellup = m_pFieldUp [ x ];
  unsigned char celldown = m_pFieldDown [ x ];
  if y > 0
    return cellup < y
  else
    return cellDown > y
}
If test = false
  don't draw
else
  draw
  set m_pField [ x ] = y
```

With continuing reference to FIGS. 1-6, FIG. 7 is a simplified functional block diagram of an exemplary operating environment 700, with which aspects of DVAS 101 may be implemented or used. Operating environment 700 is indicative of a wide variety of general-purpose, special-purpose, client- or server-based, stand-alone or networked computing environments. Operating environment 700 may be, for example, a type of computer, such as a personal computer, a workstation, a server, a portable communication device, a personal digital assistant, an in-vehicle device, a laptop, a tablet, or any other type of stand-alone or networked computing device or component thereof now known or later developed. Operating environment 700 may also be a distributed computing network or Internet-based service, for example.

One or more components shown in FIG. 7 may be packaged together or separately to implement functions of operating environment 700 (in whole or in part) in a variety of ways. As shown, a bus 721 carries data, addresses, control signals and other information within, to, or from computing environment 700 or components thereof.

Communication interface(s) 710 are one or more physical or logical elements that enhance the ability of operating environment 700 to receive information from, or transmit information to, another operating environment (not shown) via a communication medium. Examples of communication media include but are not limited to: wireless or wired signals; computer-readable storage media; computer-executable instructions; communication hardware or firmware; and communication protocols or techniques.

Specialized hardware/firmware 742 represents any hardware or firmware that implements functions of operating environment 700. Examples of specialized hardware/firmware 742 include encoder/decoders (“CODECs”), decrypters, application-specific integrated circuits, secure clocks, and the like.

A processor 702, which may be one or more real or virtual processors, controls functions of operating environment 700 by executing computer-executable instructions 706 (discussed further below).

Computer-readable media 704 represent any number and combination of local or remote components, in any form, now known or later developed, capable of recording, storing, or transmitting computer-readable data, such as instructions 706 (discussed further below) executable by processor 702. In particular, computer-readable media 704 may be, or may include persistent memory 310 and main memory 311, and may be in the form of: a semiconductor memory (such as a read only memory (“ROM”), any type of programmable ROM (“PROM”), a random access memory (“RAM”), or a flash memory, for example); a magnetic storage device (such as a floppy disk drive, a hard disk drive, a magnetic drum, a magnetic tape, or a magneto-optical disk); an optical storage device (such as any type of compact disk or digital versatile disk); a bubble memory; a cache memory; a core memory; a holographic memory; a memory stick; or any combination thereof. Computer-readable media 104 may also include transmission media and data associated therewith. Examples of transmission media/data include, but are not limited to, data embodied in any form of wireline or wireless transmission, such as packetized or non-packetized data carried by a modulated carrier signal.

Computer-executable instructions 706 represent any signal processing methods or stored instructions that electronically control predetermined operations on data. In general, computer-executable instructions 706 are implemented as software programs according to well-known practices for component-based software development, and encoded in computer-readable media (such as one or more types of computer-readable storage media 704). Software programs may be combined or distributed in various ways.

User interface(s) 716 represent a combination of presentation tools and controls that define the way user 111 interacts with operating environment 700. One type of user interface 716 is a graphical user interface (“GUI”), although any known or later developed type of user interface is possible. Presentation tools are used to receive input from, or provide output to, a user. An example of a physical presentation tool is a display such as a monitor device. An example of a logical presentation tool is a data organization technique (for example, a window, a menu, or a layout thereof). Controls facilitate the receipt of input from a user. An example of a physical control is an input device such as a remote control, a display, a mouse, a pen, a stylus, a trackball, a keyboard, a microphone, or a scanning device. An example of a logical control is a data organization technique (for example, a window, a menu, or a layout thereof) via which a user may issue commands. It will be appreciated that the same physical device or logical construct may function as an interface for both inputs to, and outputs from, a user.

Various aspects of an operating environment and an architecture/techniques that are used to implement aspects of DVAS 101 have been described. It will be understood, however, that all of the described elements need not be used, nor must the elements, when used, be present concurrently. Elements described as being computer programs are not limited to implementation by any specific embodiments of computer programs, and rather are processes that convey or transform data, and may generally be implemented by, or executed in, hardware, software, firmware, or any combination thereof.

Although the subject matter herein has been described in language specific to structural features and/or methodological acts, it is also to be understood that the subject matter defined in the claims is not necessarily limited to the specific features or acts described above. Rather, the specific features and acts described above are disclosed as example forms of implementing the claims.

It will further be understood that when one element is indicated as being responsive to another element, the elements may be directly or indirectly coupled. Connections depicted herein may be logical or physical in practice to achieve a coupling or communicative interface between elements. Connections may be implemented, among other ways, as inter-process communications among software processes, or inter-machine communications among networked computers.

The word “exemplary” is used herein to mean serving as an example, instance, or illustration. Any implementation or aspect thereof described herein as “exemplary” is not necessarily to be constructed as preferred or advantageous over other implementations or aspects thereof.

As it is understood that embodiments other than the specific embodiments described above may be devised without departing from the spirit and scope of the appended claims, it is intended that the scope of the subject matter herein will be governed by the following claims.

What is claimed is:

1. A method for visually representing occurrences of defined events within a computing system, the computing system having a plurality of computing system components, the method comprising:
identifying trace data obtained during operation of the computing system, the trace data including records of occurrences of the defined events within the computing system;
parsing the trace data;
based on parsing, implicitly or explicitly populating a plurality of data units with items of data representing data values stored in one or more computer-readable storage media, each data unit associated with a particular defined event and having a plurality of declaratory language data structures associated therewith, the data structures including
a first data structure populated with an item of first data representing the particular defined event,
a second data structure populated with an item of second data representing a particular computing system component with which the particular defined event is associated,
a third data structure populated with an item of third data representing a timestamp of the particular defined event, and
a fourth data structure populated with one or more items of fourth data representing metrics associated with the particular defined event;
generating a plurality of data collections, each data collection comprising a subset of the plurality of data units, each data unit of a particular data collection having one or more items of data in common, each of the one or more items of data in common defining a pivot item, each pivot item having a type;
generating a data collection set comprising a subset of the plurality of data collections, each data collection of the data collection set having at least one type in common;
generating a structured representation of the data collection set, the structured representation having a plurality of nodes, a particular node corresponding to a unique permutation of the one or more pivot items;
processing at least some of the nodes of the structured representation to identify one or more data units associated with each processed node;
identifying a coordinate system for visually rendering a plurality of geometric objects within an n-dimensional space, each geometric object corresponding to a particular identified data unit associated with a particular node and specified within the coordinate system using one or more coordinate values, a particular coordinate value specified via an expression, the expression having at least one operand comprising a variable representing an item of data of a particular identified data unit;
for a particular identified data unit associated with a particular node, using a particular variable, indirectly retrieving from the one or more computer-readable storage media the data value represented by the item of data represented by the particular variable;
based on the retrieved data value, evaluating the expression to obtain a particular coordinate value for a particular geometric object; and
based on the particular coordinate value, visually rendering the geometric object within the coordinate system.

2. The method according to claim 1, wherein
the coordinate system uses two coordinate values, a first coordinate value of a particular geometric object specified via a first expression and a second coordinate value of the particular geometric object specified via a second expression, the first expression and the second expression each having at least one operand comprising a variable representing an item of data of a particular defined data unit, the variable of the first expression representing the item of third data, representing the timestamp of the particular identified data unit, the variable of the second expression representing one or more items of fourth data, representing metrics associated with the particular identified data unit,
for a particular identified data unit associated with a particular node, using the variables, indirectly retrieving the data values represented by the items of data represented by the variables,
based on the retrieved data values, evaluating the first expression to obtain a first coordinate value for a particular geometric object, and evaluating the second expression to obtain a second coordinate value for the particular geometric object.

3. The method according to claim 2, wherein
the n-dimensional space comprises a two-dimensional space, and
the first expression is evaluated to transform the timestamp into a an x-coordinate value for the particular geometric object, and
the second expression is evaluated to transform one or more metrics into a y-coordinate value for the particular geometric object.

4. The method according to claim 1, further comprising:
generating a plurality of data collection sets; and
in a user selectable manner, dynamically and concurrently rendering a plurality of sets of geometric objects, a particular set of geometric objects associated with a particular data collection set, to provide different visual representations of occurrences of defined events within the computing system.

5. The method according to claim 4, wherein each particular set of geometric objects is rendered pursuant to a particular coordinate system, each geometric object corresponding to a particular identified data unit associated with a particular data collection set and specified within the particular coordinate system using at least two coordinate values, a first coordinate value specified via a first expression and a second coordinate value specified via a second expression, the first expression and the second expression each having at least one operand comprising a variable representing an item of data of a particular identified data unit associated with the particular data collection set,
the method further comprising:
identifying synchronizable operands, synchronizable operands comprising operands associated with different coordinate systems that represent items of data representing data values with common data types or units;
in a user-selectable manner, propagating a change in a particular set of geometric objects specified within a particular coordinate system using a synchronizable operand to one or more other sets of geometric objects specified within one or more other particular coordinate systems using the synchronizable operand.

6. The method according to claim 5, wherein the computing system is selected from the group comprising a distributed computing system and a non-distributed computing system, the method further comprising:
forming a first data silo based on the plurality of data collection sets, the first data silo associated with the trace data;
identifying additional trace data obtained during operation of the computing system;
parsing the additional trace data to form a second data silo based on a plurality of data collection sets generated from the additional trace data;
in a user selectable manner, dynamically rendering the plurality of sets of geometric objects, at least one set of geometric objects associated with a data collection set of the first data silo, and at least one set of geometric objects associated with a data collection set of the second data silo.

7. The method according to claim 1, wherein prior to generating the structured representation, the method further comprises:
presenting one or more user-selectable visual objects to a user via a user interface, a particular user-selectable visual object corresponding to a particular pivot item;
receiving via the user interface a user selection of one or more user-selectable objects; and
based on the user selection, generating the structured representation, the unique permutations of at least some of the pivot items, and an arrangement of the corresponding nodes, based on the particular pivot items corresponding to the user selection.

8. The method according to claim 1, wherein identifying a coordinate system comprises
presenting one or more user-selectable visual objects to a user via a user interface, a particular user-selectable visual object corresponding to a particular coordinate system,
receiving via the user interface a user selection of a particular user-selectable visual object, and
based on the user selection, identifying the coordinate system.

9. The method according to claim 1, wherein
the computing system components are selected from the group comprising processing units, data processing operations, and resources, and
each computing system component has a component type, each defined event has an event type, and a particular item of data has a data value type representing a type or measurement unit associated with a particular data value referred to by the particular item of data.

10. The method according to claim 9, wherein
The one or more pivot items are selected from the group comprising an item of first data, an item of second data, and an item of third data, and
the at least one type in common is selected from the group comprising a component type, an event type, and a data value type.

11. The method according to claim 1, wherein each data unit further includes a unique data unit index for identifying the data unit.

12. The method according to claim 11, wherein retrieving the data values represented by the items of data referred to by the variables comprises
for the particular identified data unit, using the unique data unit index to indirectly retrieve the data values.

13. The method according to claim 12, wherein each data unit further includes
a fifth data structure populated with one or more items of fifth data comprising one or more selection indicators, for indicating whether any data values associated with any items of data of a particular data unit are selected for retrieval from a particular computer-readable storage medium, and
wherein processing at least some of the nodes of the structured representation to identify one or more data units associated with each processed node comprises, for each particular identified data unit, setting a particular selection indicator.

14. The method according to claim 13, further comprising:
populating a matrix with unique data unit indices of particular identified data units having the particular selection indicator set; and
using the matrix to indirectly retrieve the data value.

15. The method according to claim 14, further comprising:
after identifying the coordinate system and retrieving the data value,
in real time, receiving a user selection of a new coordinate system,
identifying a new variable of new a new expression of the new coordinate system, the new variable representing an item of data of particular identified data unit; and
using the matrix and the new variable, indirectly retrieving the data value.

16. The method according to claim 1, wherein each data unit comprises a base unit portion and an extended unit portion, the data values represented by items of data associated with the base unit portion stored in a non-persistent memory, and the data values represented by items of data associated with the extended unit portion stored in a persistent memory.

17. The method according to claim 1, wherein
a particular data collection has a metadata data structure associated therewith, for aggregating pivot items between data units of a particular data collection.

18. The method according to claim 17, wherein the data collection set has a descriptor data structure, which stores information about how the identified coordinate system relates to the items of data aggregated by the metadata data structures of the data collections comprising the data collection set.

19. A computer-readable storage medium encoded with computer-executable instructions which, when executed by a processor, perform a method for visually representing occurrences of defined events within a computing system, each defined event having an event type, the computing system having a plurality of computing system components, the method comprising:
identifying trace data obtained during operation of the computing system, the trace data including records of occurrences of the defined events within the computing system;
parsing the trace data;
based on parsing, populating a plurality of data units with items of data representing data values stored in one or more computer-readable storage media, each data unit associated with a particular defined event having an event type, each data unit having a plurality of declarative language data structures, the data structures including
a first data structure populated with an item of first data representing the particular defined event,
a second data structure populated with an item of second data representing a particular computing system component with which the particular defined event is associated,
a third data structure populated with an item of third data representing a timestamp of the particular defined event, and
a fourth data structure populated with one or more items of fourth data representing metrics associated with the particular defined event;
generating a plurality of data collections, each data collection comprising a subset of the plurality of data units, each data unit of a particular data collection having one or more items of data in common;
receiving a user selection of a particular event type;
based on the particular event type, identifying a data collection set comprising a subset of the plurality of data collections, each data collection of data collection set having the particular event type in common;
generating a structured representation of the data collection set, the structured representation having a plurality of nodes, a particular node corresponding to a particular defined event of the particular event type;
processing the nodes of the structured representation to identify one or more data units associated with each node;
during processing, for each identified data unit associated with a particular node, incrementing an event counter; and
visually rendering a plurality of points in a two-dimensional coordinate system, each point corresponding to a particular identified data unit associated with a particular node, each point specified within the coordinate system using a first coordinate value comprising the timestamp referred to by the item of third data of the particular identified data unit, and a second coordinate value comprising a value of the event counter at a time associated with the timestamp,
the visually rendered plurality of points facilitating perception of recurring patterns that suggest a causal relationship between different defined events.

20. A system for visually representing occurrences of defined events within a computing system having a plurality of computing system components, the system comprising:
a user interface;
a computer-readable storage medium; and
a processor responsive to the computer-readable storage medium and to a computer program, the computer program, when loaded into the processor, operable to perform a method comprising
identifying trace data obtained during operation of the computing system, the trace data including records of occurrences of the defined events within the computing system,
parsing the trace data to implicitly or explicitly populate a plurality of data units with items of data, each data unit associated with a particular defined event and having a plurality of associated declarative language data structures, the data structures including
a first data structure populated with an item of first data representing the particular defined event,
a second data structure populated with an item of second data representing a particular computing system component with which the particular defined event is associated,
a third data structure populated with an item of third data representing a timestamp of the particular defined event, and
a fourth data structure populated with one or more items of fourth data representing metrics associated with the particular defined event,
generating a plurality of data collections, each data collection comprising a subset of the plurality of data units, each data unit of a particular data collection having one or more items of data in common, each item of data in common defining a pivot item, each pivot item having a type,
receiving a first user selection of one or more particular pivot items or particular types or both,
based on the first user selection, generating a data collection set comprising a subset of the plurality of data collections, each data collection of the data collection set having in common the selected one or more particular pivot items or particular types or both,
based on the selected one or more particular pivot items or particular types or both, generating a structured representation of the data collection set, the structured representation having a plurality of nodes, a particular node corresponding to a unique permutation of the selected one or more particular pivot items or particular types or both,
processing at least some of the nodes of the structured representation to identify one or more data units associated with each node,
identifying a plurality of coordinate systems, a plurality of geometric objects renderable within a particular coordinate system, each geometric object corresponding to a particular identified data unit associated with a particular node, a particular coordinate system specifying a particular geometric object within a particular coordinate system using a first coordinate value based on the timestamp referred to by the item of third data of a particular identified data unit, and a second coordinate value based on one or more metrics referred to by the one or more items of fourth data of the particular identified data unit,
receiving a second user selection of a particular coordinate system, and
via the user interface, visually rendering the plurality of geometric objects within the selected particular coordinate system,
the first and second user selections dynamically changeable to generate different visual representations of occurrences of defined events within the computing system.
